(19) United States
(12) Patent Application Publication
(10) Pub. No.: US 2005/0226393 A1
(43) Pub. Date: Oct. 13, 2005

(54) Voice over DSL adapter for test equipment

(76) Inventors: Donald S. Smith, Vinemont, AL (US); Steven Ryals, Pinson, AL (US)

Correspondence Address: CANTOR COLBURN LLP, 55 GRIFFIN ROAD SOUTH, BLOOMFIELD, CT, 06002, US

(21) Appl. No.: 10/820,960

(22) Filed: Apr. 8, 2004

(51) Int. Cl. H04M 1/24; H04M 3/08

(52) U.S. Cl. 379/22

(57) ABSTRACT

Exemplary embodiments include an adapter for test equipment. The adapter includes a positive connector for making electrical connection with a first telecommunications line and a positive lead connected to the positive connector. A negative connector makes electrical connection with a second telecommunications line and a negative lead is connected to the negative connector. A low pass filter is connected to the positive lead and negative lead. A positive butt-set connection is connected to the low pass filter and a negative butt-set connection is connected to the low pass filter.

### BACKGROUND OF INVENTION

Embodiments of the invention relate generally to test equipment and, more particularly, to a voice over digital subscriber line (DSL) adapter for use with test equipment.

Maintenance, monitoring and troubleshooting of a telecommunications line is performed by a lineman or network technician employed by the network provider. Often, the technician needs to contact network personnel (e.g., central office) and is unable to do so because cellular phone reception is unavailable. The technician may carry test equipment such as a hand-held butt-set or test set to test the telephone line for proper ringing signals, dial tone reception, noise level, etc. The butt-set, however, cannot be used to place a voice call over lines carrying DSL signals. The standard butt-set (dial tone test set receiver) allows DSL signals into the receiver rendering communication ineffective. Also, directly connecting the butt-set to a line carrying DSL can interrupt DSL service to a customer by interrupting DSL synchronization.

Thus, there is a need for an apparatus that facilitates using test equipment to place voice calls on lines carrying DSL signals.

### SUMMARY OF INVENTION

Embodiments of the invention include an adapter for test equipment. The adapter includes a positive connector for making electrical connection with a first telecommunications line and a positive lead connected to the positive connector. A negative connector makes electrical connection with a second telecommunications line and a negative lead is connected to the negative connector. A low pass filter is connected to the positive lead and negative lead. A positive butt-set connection is connected to the low pass filter and a negative butt-set connection is connected to the low pass filter.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 depicts a voice over DSL adapter in embodiments of the invention;

FIG. 2 is a schematic diagram of a voice over DSL adapter in embodiments of the invention;

FIG. 3 is a schematic diagram of a voice over DSL adapter in alternate embodiments of the invention; and

FIG. 4 is a schematic diagram of a voice over DSL adapter in alternate embodiments of the invention.

### DETAILED DESCRIPTION

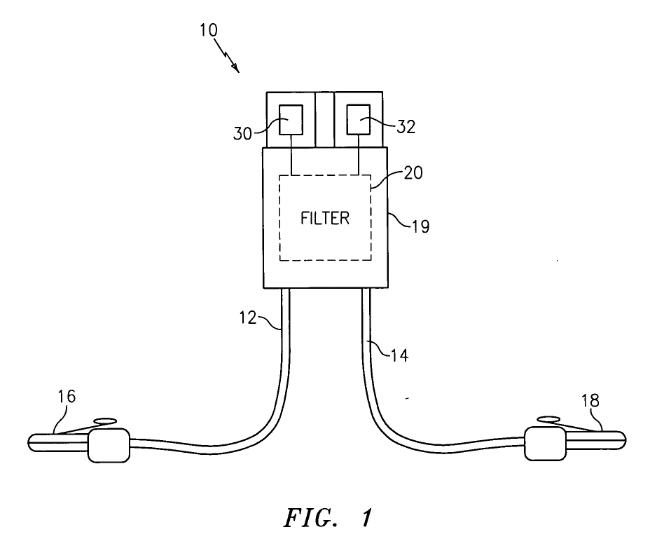

FIG. 1 depicts a voice over DSL adapter 10 in embodiments of the invention. Adapter 10 includes a positive lead 12 and a negative lead 14 terminating in a positive connector 16 and a negative connector 18. In exemplary embodiments, the positive connector 16 and negative connector 18 are banana clips or alligator clips. Positive connector 16 and negative connector 18 connect to a cable pair, binding post or other connection point of a telecommunication line. A housing 19 includes a low pass filter 20 that rejects high frequency DSL signals and allows lower frequency POTS (dial tone and voice) to pass through to positive and negative butt-set connections 30 and 32. The butt-set connections 30 and 32 receive clips from a standard butt-set or other type of test equipment. Adapter 10 allows a technician to place a voice call over a line carrying DSL signals without encountering interference from the DSL signals or interrupting the DSL service to the end-user.

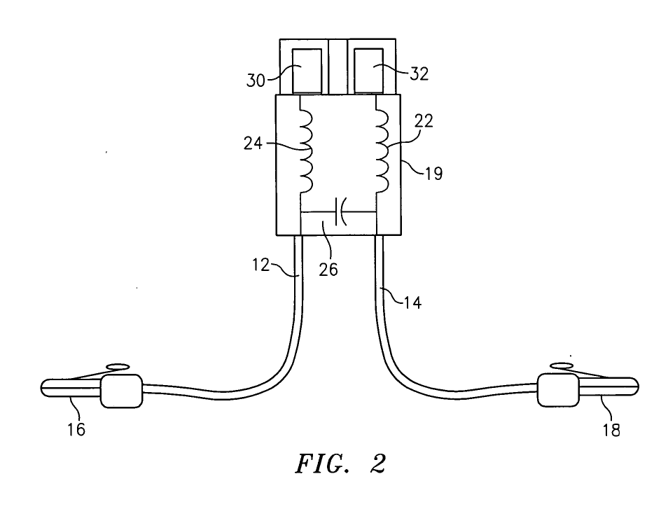

FIG. 2 is a schematic diagram of a voice over DSL adapter in embodiments of the invention. Filter 20 includes inductors 22 and 24 and a capacitor 26. Inductor 22 is in series with negative lead 14 and negative butt-set connection 32. Inductor 24 is in series with positive lead 12 and positive butt-set connection 30. Capacitor 26 is in parallel with positive lead 12 and negative lead 14. The inductors 22 and 24 and capacitor 26 form a low pass filter allowing POTS to pass to the butt-set connections 30 and 32. The higher frequency DSL signals are shorted across capacitor 26 while the lower frequency POTS signals are passed across inductors 22 and 24. This allows a technician operating a butt-set to place a call without encountering interference from the DSL signals or interrupting the DSL service to the end-user.

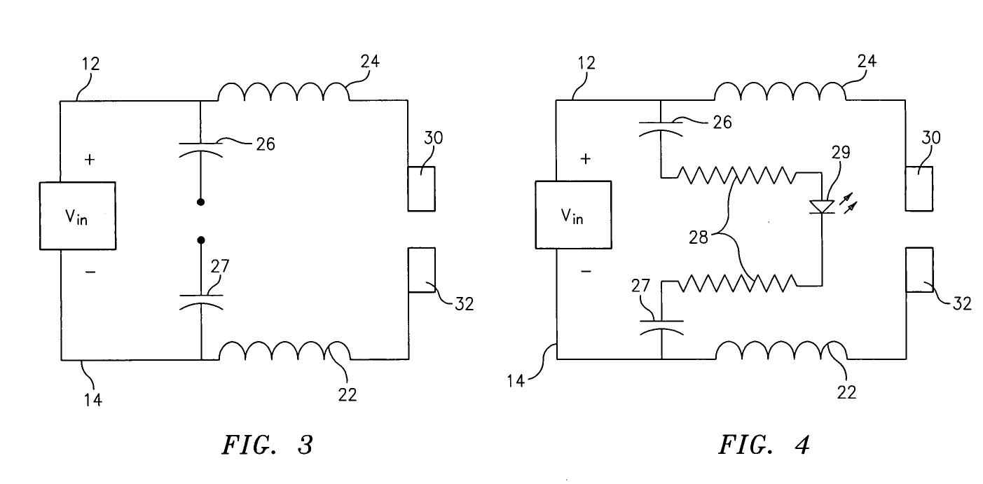

FIG. 3 is a schematic diagram of a voice over DSL adapter in alternate embodiments of the invention. In this embodiment, capacitor 26 is not in parallel across leads 12 and 14, but rather shunts high frequency DSL signals to open. An additional capacitor 27 (optional) is coupled to the negative led 14 and shunts high frequency DSL signals to open. The lower frequency POTS signals are passed across inductors 22 and 24 to butt-set connections 30 and 32.

FIG. 4 is a schematic diagram of a voice over DSL adapter in alternate embodiments of the invention. In these embodiments, capacitors 26 and 27 direct high frequency DSL signals to a visual indicator 29 (such as a light emitting diode or LED) through resistors 28. The DSL signal is dissipated over resistors 28 and LED 29. The use of an LED allows a technician to visually determine if DSL signals are present on the line. More complex circuitry may be used in place of the resistors 28 and LED 29 to provide further troubleshooting and testability. The lower frequency POTS signals are passed across inductors 22 and 24 to butt-set connections 30 and 32.

Embodiments of the invention allow a technician to establish a voice call over a line carrying DSL signals without encountering interference from the DSL signals or interrupting the DSL service to the end-user. This facilitates communication for the technician and expedites network diagnostics, troubleshooting, maintenance, etc.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. An adapter for test equipment, the adapter comprising:
a positive connector for making electrical connection with a first telecommunications line;
a positive lead connected to said positive connector;
a negative connector for making electrical connection with a second telecommunications line;
a negative lead connected to said negative connector;
a low pass filter connected to said positive lead and negative lead;
a positive butt-set connection connected to said low pass filter; and
a negative butt-set connection connected to said low pass filter.

2. The adapter of claim 1 wherein:
said low pass filter is an inductor-capacitor filter.

3. The adapter of claim 2 wherein:
said low pass filter includes:
a first inductor in series with said positive lead and said positive butt-set connection;
a second inductor in series with said negative lead and said negative butt-set connection; and
a capacitor in parallel with said positive lead and said negative lead.

4. The adapter of claim 2 wherein:
said low pass filter includes:
a first inductor in series with said positive lead and said positive butt-set connection;
a second inductor in series with said negative lead and said negative butt-set connection; and
a capacitor connected to said positive lead.

5. The adapter of claim 4 wherein:
said low pass filter further includes a second capacitor connected to said negative lead.

6. The adapter of claim 1 further comprising:
a visual indicator connected to said low pass filter providing a visual indication of high frequency signals dissipated through said low pass filter.

7. The adapter of claim 1 further comprising:
said low pass filter includes:
a first inductor in series with said positive lead and said positive butt- set connection;
a second inductor in series with said negative lead and said negative butt-set connection; and
a capacitor connected to said positive lead;
a second capacitor connected to said negative lead;
a resistor connected to said capacitor;
a second resistor connected to said second capacitor;
a visual indicator connected to said resistor and said second resistor.

8. The adapter of claim 7 wherein:
said visual indicator is a light emitting diode.

9. The adapter of claim 1 wherein:
said positive connector and said negative connector are clips.
